(19) United States
(12) Patent Application Publication
(10) Pub. No.: US 2005/0021653 A1
(43) Pub. Date: Jan. 27, 2005

(54) Multimedia search and browsing method using multimedia user profile

(75) Inventors: Jung-Min Song, Seoul (KR); Jin-Soo Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/815,753

(22) Filed: Apr. 2, 2004

Related U.S. Application Data
(63) Continuation of application No. 09/666,282, filed on Sep. 21, 2000.

(30) Foreign Application Priority Data
Sep. 22, 1999 (KR) 41189/1999

(51) Int. Cl. G06F 15/16

(52) U.S. Cl. 709/207

(57) ABSTRACT

The present invention relates to a method for generating a multimedia user profile, and a multimedia search and browsing method using the user profile, which is capable of displaying search items in order of higher user preference to the ordering criteria of the search item that the user prefers, and searching and browsing a multimedia object using the search items displayed according to the user preference. The present invention can be adapted to multimedia service systems such as a digital VTR (Video Tape Recorder), a VOD (Video On Demand), an AOD (Audio On Demand), and an Internet. In addition, the user profile for searching and browsing the multimedia according to the present invention can creates an environment that a user can perform a convenient and easy method of searching and browsing the user-desired multimedia object according to the user preference.

### BACKGROUND OF THE INVENTION

This application is a Continuation of U.S. patent application Ser. No. 09/666,282, filed Sep. 21, 2000, entitled MULTIMEDIA SEARCH AND BROWSING METHOD USING MULTIMEDIA USER PROFILE INFORMATION STRUCTURE, which claims priority to Korean Application No. 41189/1999, filed Sep. 22, 1999, the entire disclosure of which is considered as being part of the disclosure of this application and is hereby incorporated by reference herein.

1. Field of the Invention

The present invention relates to a method of generating a multimedia user profile and a multimedia search and browsing method using the multimedia user profile, in particular to the multimedia search and browsing method using the multimedia user profile, which is capable of displaying search items in accordance with user preference, and searching and browsing relevant multimedia by using the search items displayed according to the user preference.

2. Description of the Related Art

Conventionally a user can watch television by receiving a video and an audio signal from a broadcasting station, and can watch a movie in a theater.

However, the user may want to watch a certain segment of a drama or movie, accordingly in order to make the user select a certain segment of the drama or movie, related technologies have been presented according to development of various video mediums.

For example, the user can choose a movie or a drama selectively by connecting to a video provider through a network such as a LAN (Local Area Network).

In addition, the user can selectively reproduce a certain moving picture segment in the selected drama or movie which shows a character, an accident, a place, or an article the user wants to watch.

In addition, the user can automatically summarily reproduce important parts of video contents such as a news program, a sports program, a movie without reproducing the whole, and can reproduce custom-tailored moving picture segment by setting key frames representing each moving picture segment and displaying the key frames.

There are certain technologies to perform above-mentioned function.

For example, there is a technology that represents various video contents in a unit of groups such as a pattern group, an index group, a medium group, a segment group, an object group or a representation group, displays information about a character and an article (object name, position on a screen, numerical value that an object is appeared on the video contents, etc.) from the object group and representation group, and reproduces a certain video segment that the object is appeared when the user selects the object from the table of the object group.

There is the other technology which is capable of providing tables about various additional information of video contents which can be made before, during, after production of the video contents.

For example, the additional information tables can provide information related to positions where characters and articles are appeared in the video contents, and it can produce the pertinent scene when the user selects an object from the table.

In addition, when the selected object is an article, it displays information about the article (manufacturer, price etc.), and connects to the manufacturer/sales agency of the article.

There is another technology, which is capable of providing a partial map having information about each part of video contents.

In other words, the partial map displays the information about the each part of the video contents (violence, suggestiveness, importance, characters, positions, difficulty, etc.), the user can reproduce the desired part among the video contents by registering user preference about the items of the partial map, and can restrict transmission of a certain content to unidentified users.

There is another technology, which is capable of illustrating a temporal connection graph of moving picture shots.

However, by watching only the temporal connection graph of the moving picture shots, it is difficult to clearly understand a story development of the moving picture contents because it is as same as understanding entire contents using only a few representative scenes.

The above-described conventional moving picture search technologies just display some items simply listing-up various information about the objects appearing in the drama or movie, and perform the function according to selection of the user.

In addition, it is possible to search and browse the multimedia efficiently because the user can get the part of the multimedia related to the selected item.

However, search and browsing items have to be increased in accordance with increase of the number of multimedia. Accordingly, technologies for selectively displaying search items in accordance with user preference have been introduced.

For example, there is an automatic setting method which is capable of setting a system automatically when the user approaches to the system by storing a television channel, a music genre, volume of the music preferred by the user and using the stored information.

There is another method which is capable of searching a program in accordance with user preference by comparing information such as characters, program genre, category of sports, sports team stored in a program character table with a user preference table.

There is another method, which is capable of searching products corresponding to a request of the user by comparing a stored character (size, price, capability, etc.) of the products with the character requested by the user.

There is another method, which is capable of automatically setting parameters of a video display unit such as a volume, brightness by learning preference of the user.

There is another method, which is capable of displaying e-mails in accordance with user preference whenever the user checks the e-mails.

There is another method, which is capable of providing a custom-tailored electronic newspaper by learning preference of the user.

The above-described multimedia search and browsing systems store preference about search items to be searched/browsed, and search/browse the multimedia in accordance with the preference.

In the above—systems a searcher and a browser display search items (character, place, incident, article, key frame, etc.) to the user, there are many methods to display the search items to the user.

For example, the search items can be displayed according to various criteria such as alphabetical order, number of appearance, priority, occurrence order, etc.

The each user can have different preference about the criteria, but the conventional technologies did not consider the preference difference in the criteria.

### SUMMARY OF THE INVENTION

The object of the present invention is to provide a method of generating a multimedia user profile and a multimedia search and browsing method using the multimedia user profile, which is capable of displaying search items in accordance with a user preference and searching and browsing relevant multimedia by using the search items displayed in accordance with the user preference.

In order to achieve above-mentioned object, the multimedia user profile is generated by incorporating ordering criteria information of a search item for searching and browsing the multimedia object, and incorporating user preference information on ordering criteria of the search item to display the search item to be browsed in a user preferred arrangement.

In order to achieve above-mentioned object, there is provided a method for generating search item preference information in indexing and browsing a multimedia object, comprising: constructing a multimedia object by incorporating a search object which is the multimedia data stream, a search item which is criterion of indexing, connection information which connects each search item to the search object, ordering criteria information for indicating ordering criteria of each search item, and ordering information according to each ordering criterion; and constructing a user profile by incorporating item categories for indicating items which can be criteria of the search and browsing, and a user preference value indicating preference to the ordering information of the multimedia object on each item category.

In order to achieve above-mentioned object, there is provided a multimedia search and browsing method using multimedia user profile information in indexing and browsing a multimedia object, comprising: (a) identifying ordering criteria information of the search item and user preference information on the ordering criteria of the search item from the user profile; (b) displaying search items in order of higher user preference on the basis of the item ordering criteria according to the user preference; and (c) searching and browsing the search object indicated by the search items displayed according to the user preference.

In order to achieve above-mentioned object, there is also provided a multimedia search and browsing method using a user profile information in indexing and browsing a multimedia object, comprising: (a) identifying a search item which is criterion of indexing and ordering criteria information for indicating ordering criteria of each search item from the multimedia object; (b) identifying item categories for indicating items which can be criteria of the search and browsing and a user preference value indicating preference to the ordering information of the multimedia object on each item category from the user profile; (c) selecting the ordering criteria information in order of higher preference value of the user profile on each search item; (d) displaying the multimedia items based on the user preference by using the ordering criteria information selected from the user profile; and (e) searching and browsing the search object indicated by the search items displayed according to the user preference.

### BRIEF DESCRIPTION OF THE DRAWINGS

FIG. 1 illustrates a multimedia data structure according to the embodiment of the present invention.

FIG. 2 illustrates one embodiment of the multimedia data structure in FIG. 1.

FIG. 3A-3D illustrates another embodiment of the multimedia data structure in FIG. 1.

FIG. 4 illustrates a structure of search item ordering criteria preference information according to the present invention.

FIG. 5 illustrates a structure of search item preference information according to the present invention.

FIG. 6 illustrates an embodiment of the search item preference according to the present invention.

FIG. 7 illustrates a video browser using the user preference in FIG. 6.

FIG. 8A-8B illustrates ordering information of a multimedia object in accordance with the ordering criteria information.

FIG. 9 illustrates a structure of search item ordering criteria preference information by using the multimedia object in FIG. 8.

### DETAILED DESCRIPTION OF THE PREFERRED EMBODIMENT

FIG. 1 illustrates a multimedia data structure according to the embodiment of the present invention.

As depicted in FIG. 1, a multimedia object 101 comprises a search item 102 for searching and browsing, and a search object 103 for being searched and browsed.

The search item 102 comprises category of item 104 indicating categories of the item, and search object connection information 105 for connecting to the search object.

When the multimedia object 101 is moving picture, items comprised in the search item 102 can be a character or an event.

The search object 103 can be a segment showing the character or event, and the search object connection information 105 can be information for connecting a pertinent character and event to a pertinent segment.

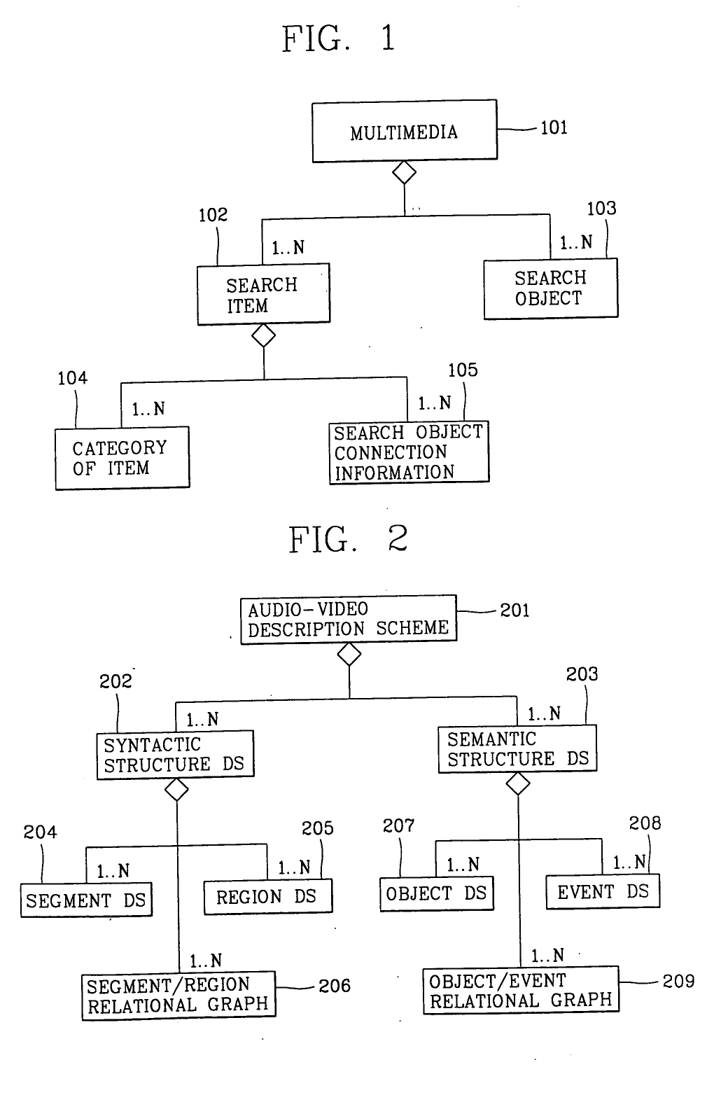

FIG. 2 illustrates one embodiment of the multimedia data structure in FIG. 1.

First, an audio-video description scheme 201 comprises a syntactic DS (Description Scheme) 202 for describing a segment showing the multimedia object, and a semantic DS (Description Scheme) 203 for describing meaningful information.

The syntactic DS (Description Scheme) 202 comprises a segment DS (Description Scheme) 204 as a real moving picture segment, a region DS (Description Scheme) 205, and a segment/region relation graph 206.

The semantic DS (Description Scheme) 203 comprises an object DS (Description Scheme) 207 for describing object information such as a character or a place, an event DS (Description Scheme) 208 describing events, and an object/event relation graph 209 for describing relation between the characters, places or events.

Herein, the search item 102 comprises the segment DS (Description Scheme) 204, region DS (Description Scheme) 205, segment/region relation graph 206, object DS (Description Scheme) 207, event DS (description Scheme) 208, and object/event relation graph 209, wherein the above search items are identified by the category of item 104.

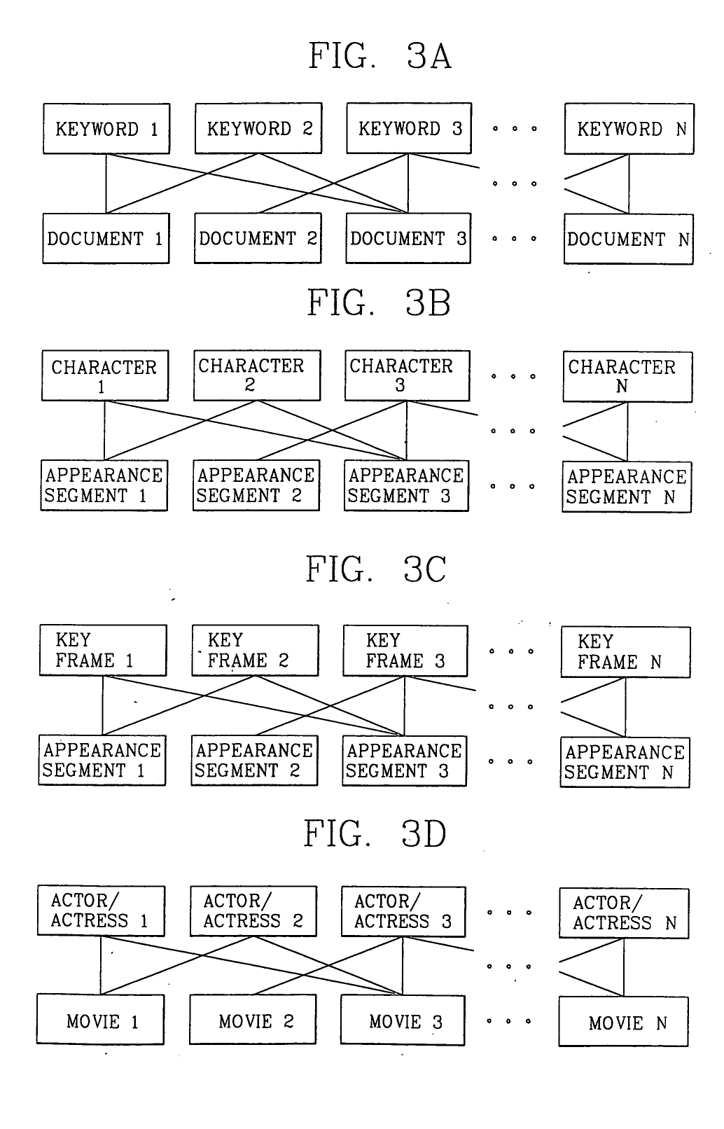

FIG. 3A-3D illustrates another embodiment of the multimedia data structure in FIG. 1.

In other words, FIG. 3A-3D illustrate examples of the category of item 104 and search object 103 of the multimedia object 101 in FIG. 1, FIG. 3A-3D will be described in detail with reference to FIG. 1.

First, the category of item 104 can be all search items such as a character, key frame, place, actor/actress, article, keyword, melody, etc.

The search object 103 can be a moving picture segment showing a character, moving picture segment represented by a key frame, a movie or a drama showing a certain actor/actress, a document comprising a certain key word, or an audio clip having a melody similar to a certain melody, etc.

FIG. 3A illustrates an ordinary text document item, wherein the text document is a key word in the category of item 104, and the search item 102 can be key word 1, key word 2, key word 3, . . . , key word N.

The search object 103 can be document 1, document 2, document 3, . . . . document N.

FIG. 3 illustrates moving picture item categories, wherein the item category is characters, the search item is character 1, character 2, character 3, . . . , character N.

In addition, the search object 103 can be appearance segment N that a pertinent character is appeared.

FIG. 3C illustrates another example of moving picture item categories, wherein the category of item 104 is a key frame, the search item 102 can be key frame 1, key frame 2, key frame 3, . . . , key frame N.

The search object 103 can be appearance segment 1, appearance segment 2, appearance segment 3, . . . , appearance segment N.

FIG. 3D illustrates another example of moving picture item categories, wherein the category of item 104 is actor name, the search item 102 can be actor 1, actor 2, actor 3, . . . , actor N.

The search object 103 can be movie 1, movie 2, movie 3, . . . , movie N that the pertinent actor appears.

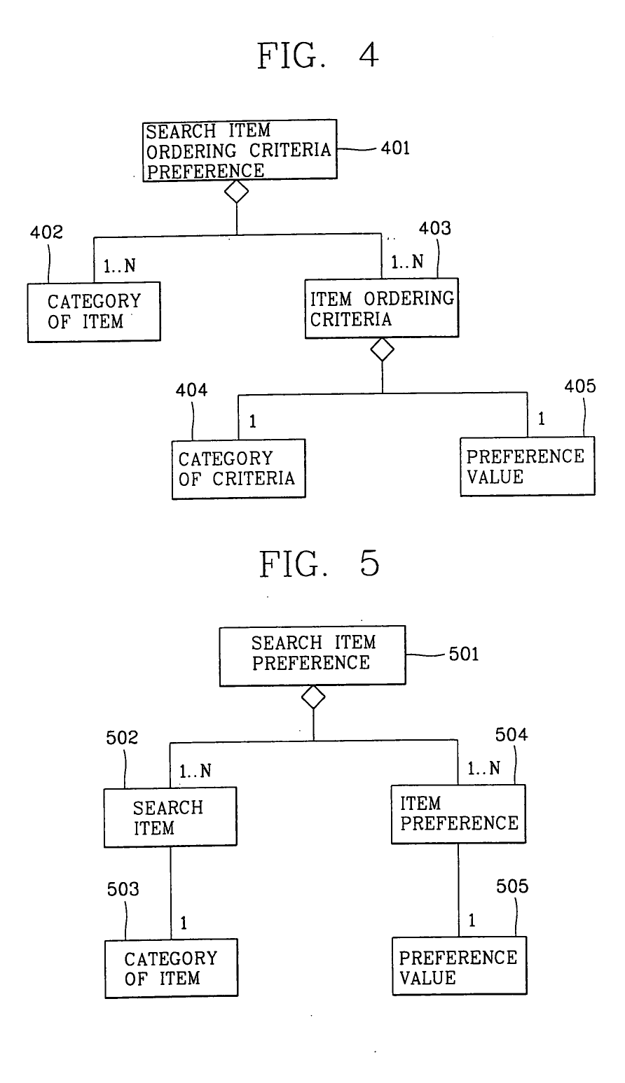

FIG. 4 illustrates a structure of search item ordering criteria preference information according to the present invention.

In other words, it describes a user profile information structure comprising preference of the search item ordering criteria reflecting a user preference to the multimedia object structure such as FIG. 1 or FIG. 3, it will now be described in detail.

First, a search item ordering criteria preference 401 comprises a category of search item 402 and an item ordering criteria 403 determining ordering of the search items according to the category of item.

The item ordering criteria 403 comprises a category of criteria 404 and a preference value 405 about each category of criteria.

Accordingly, the multimedia object in FIG. 1 or FIG. 3 can be searched by using the user profile information in FIG. 4 considering the search item ordering criteria.

In addition, in browsing of the multimedia object, the search item can be displayed by using the search item ordering criteria in accordance with the user preference.

Herein, when the user searches and browses a certain object, a search means displays the search items to the user. The ordering of search items is performed in accordance with the item ordering criteria 403 of the user profile information such as depicted in FIG. 4.

For example, when a character of moving picture is searched and browsed, the item ordering criteria 403 can be number of appearance of the character or age of the character, while when the search/browsing is performed by using a key frame of the moving picture, the item ordering criteria 403 can be temporal ordering of the moving picture represented by the key frame, brightness of the key frame image, or color of the key frame image.

In addition, the preference value 405 of the item ordering criteria 403 is information stored by the user.

When the user selects preferred criteria, stores it among the item ordering criteria 403, and uses a search means for searching and browsing, the search means displays the search items on the basis of the preference value of the user about the item ordering criteria.

FIG. 5 illustrates a search item preference information structure according to the present invention.

As depicted in FIG. 5, a search item preference 501 comprises a search item 502, a category of item 503, an item preference 504, and a preference value 505.

The category of item 503 can be characters, places, and key frames as described above.

The search item 502 can be character N when the category of item is character.

The item preference 504 describes the user preference about a certain search item among the category of item such as the character, place, key frame, etc. as the preference value 505.

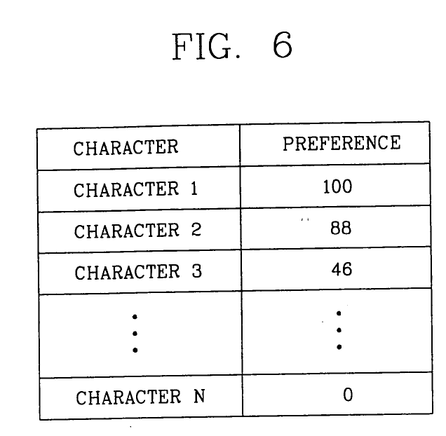

FIG. 6 illustrates the embodiment of the search item preference according to the present invention.

As depicted in FIG. 6, when a category of item is character, the user preference is described as a certain value on the each search item of the each character (character N).

For example, like preference ‘100’ of the character 1 or preference ‘46’ of the character 3, the preference value is displayed on the each search item (character).

In other words, the multimedia search and browsing means can display the characters as character 1, character 2, character 3, . . . , character N from the user profile having the preference information.

In addition, the user can easily search/browse the segments that the pertinent character appears by watching the search item displayed in order of the preference of the user.

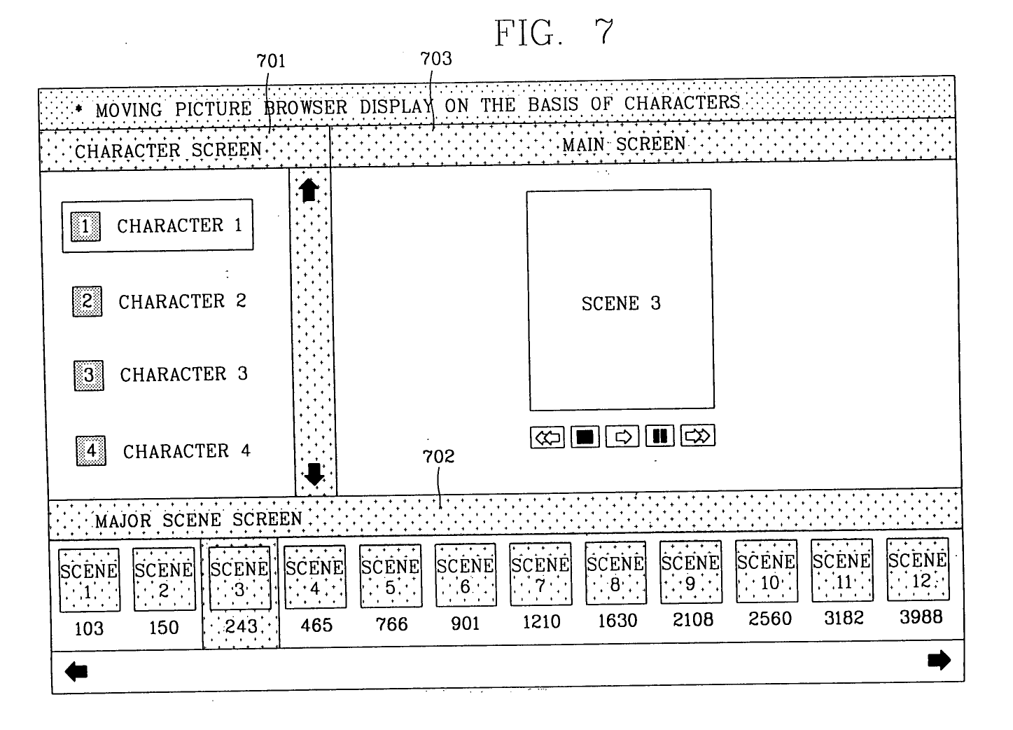

FIG. 7 illustrates a video browser using the user preference in FIG. 6.

In other words, it depicts a moving picture browser displayed on the basis of characters.

As depicted in FIG. 7, the search item is displayed on a character screen 701 from character 1 to character N (N=4) in order of the preference of the user.

Herein, when the user selects the character 1, the key frames corresponding to the moving picture (search object) that the character 1 appears are displayed on a major scene screen 702. Herein, a main screen 703 reproduces a pertinent moving picture segment when the user selects a scene 3.

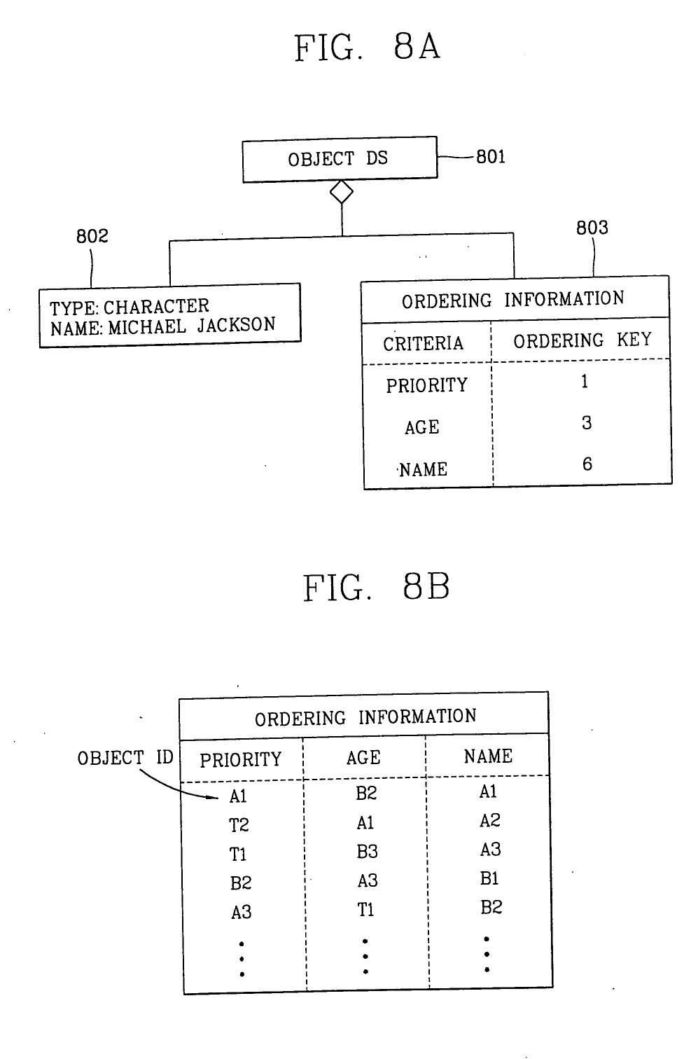

FIG. 8A-8B illustrate ordering information of a multimedia object in accordance with the ordering criteria information.

FIG. 8A illustrates a structure including ordering information on three ordering criteria (priority, age, name) for an object DS.

FIG. 8B illustrates the ordering information of a multimedia object on the basis of three ordering criteria information (priority, age, name).

In other words, when the object DS (Description Scheme) 801 is a character in the multimedia structure described in FIG. 2, the object DS (Description Scheme) 801 comprises semantic information 802 of the object indicating the object type and object name and the ordering information 803 displaying the ordering criteria information and ordering Key.

Herein, the object DS (Description Scheme) displays the ordering information on the basis of the three ordering criteria information such as a priority, age, name.

As depicted in FIG. 8B, the characters A1, T2, T1, B2, . . . are displayed in accordance with the priority, the character B2, A1, B2, . . . are displayed in accordance with the age, and the character A1, A2, A3, B1, . . . are displayed in accordance with the name.

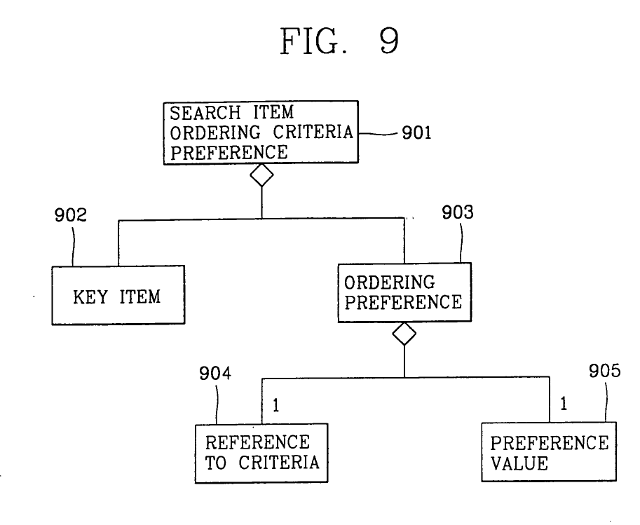

FIG. 9 illustrates a structure of search item ordering criteria preference information by using the multimedia object in FIG. 8.

As depicted in FIG. 9, a search item ordering criteria preference 901 comprises a key item 902, and an ordering Preference 903.

The ordering preference 903 comprises a reference to criteria 904, and a preference value 905.

The reference to criteria 904 indicates the ordering criteria information displayed on the multimedia object, and the preference value 905 means the preference about the referenced ordering criteria.

Accordingly, an ordering of a search item based on the user preference and the multimedia search and browsing using the ordering of the search item can be possible by referencing to the multimedia object in FIG. 8 identified from the user profile information in FIG. 9.

In other words, the reference to criteria 904 reflecting the ordering criteria preference value 905 displays search items of the multimedia object on the basis of the ordering criteria information of the multimedia object data structure in FIG. 8 by using the search item ordering criteria preference 901 described in the user profile.

After that, the search and browsing about the pertinent multimedia object are performed from the displayed information.

As described above, when the search items related to the multimedia are displayed, the present invention can efficiently perform search and browsing of the multimedia object by displaying the search item after selecting a criterion among search item ordering criteria in accordance with the user preference.

In addition, the present invention can be adapted in a multimedia service system such as a VTR (video Tape Recorder), a VOD (Video On Demand), an AOD (Audio On Demand), an Internet, etc.

In addition, the present invention is capable of searching/browsing easily the object according to preference of the user.

1. A method for generating a multimedia user profile in indexing and browsing a multimedia object, comprising:
incorporating ordering criteria information of a search item; and
incorporating user preference information on ordering criteria of the search item to display the search item to be browsed in a user preferred arrangement.

2. The method according to claim 1, wherein the user profile comprises item categories which can be criteria of search and browsing in order to display the search item to be browsed according to a user preferred arrangement.

3. The method according to claim 2, wherein the user profile further comprises item ordering criteria in order to determine the ordering of search items for each item category.

4. The method according to claim 3, wherein the item ordering criteria comprise criteria categories indicating the categories of the ordering criteria.

5. The method according to claim 4, wherein the item ordering criteria further comprise preference information indicating preference to the relevant criterion category.

6. The method according to claim 4, wherein the criteria categories represent the preference of the relevant item included in existing user profile, and the search items are displayed in accordance with the preference.

7. A multimedia search and browsing method using a multimedia user profile in indexing and browsing a multimedia object, comprising:
(a) identifying ordering criteria information of the search item and user preference information on the ordering criteria of the search item from the user profile;
(b) displaying search items in order of higher user preference on the basis of the item ordering criteria according to the user preference; and
(c) searching and browsing the search object indicated by the search items displayed according to the user preference.

8. A method for generating search item preference information in indexing and browsing a multimedia object, comprising:
constructing a multimedia object by incorporating a search object which is the multimedia data stream,
a search item which is criterion of indexing,
connection information which connects each search item to the search object,
ordering criteria information for indicating ordering criteria of each search item, and ordering information according to each ordering criterion; and
constructing a user profile by incorporating item categories for indicating items which can be criteria of the search and browsing, and
a user preference value indicating preference to the ordering information of the multimedia object on each item category.

9. A multimedia search and browsing method using a user profile information in indexing and browsing a multimedia object, comprising:
(a) identifying a search item which is criterion of indexing and ordering criteria information for indicating ordering criteria of each search item from the multimedia object;
(b) identifying item categories for indicating items which can be criteria of the search and browsing, and a user preference value indicating preference to the ordering information of the multimedia object on each item category from the user profile;
(c) selecting the ordering criteria information in order of higher preference value of the user profile on each search item;
(d) displaying the multimedia items based on the user preference by using the ordering criteria information selected from the user profile; and
(e) searching and browsing the search object indicated by the search items that the user preference is reflected.
